(19) United States
(12) Patent Application Publication
(10) Pub. No.: US 2025/0267473 A1
(43) Pub. Date: Aug. 21, 2025

(54) Methods And Apparatus For Paging Adaptation To Support Enhanced Beam Configuration In Wireless Communications

(71) Applicant: MediaTek Inc., Hsinchu City (TW)

(72) Inventors: Gilles Charbit, Cambridge (GB); Abdelkader Medles, Cambridge (GB); Pradeep Jose, Cambridge (GB); Ogeen Hanna Toma Toma, Cambridge (GB); Waseem Hazim Ozan Ozan, Cambridge (GB)

(21) Appl. No.: 19/035,777

(22) Filed: Jan. 23, 2025

Related U.S. Application Data
(60) Provisional application No. 63/554,251, filed on Feb. 16, 2024.

(51) Int. Cl. H04W 16/28; H04B 7/06; H04W 68/02; H04W 74/0833

(52) U.S. Cl. CPC H04W 16/28; H04B 7/06952; H04W 68/02; H04W 74/0833

(57) ABSTRACT

Various solutions for paging adaptation to support enhanced beam configuration in wireless communications are described. A network node may configure a cell with at least one wide beam and one or more narrow beams. The wide beam may be configured to be always activated and each of the narrow beams may be configurable to be activated or deactivated. The network node may transmit a paging message to an apparatus in the cell. The paging message may be transmitted on the wide beam and/or the narrow beams that are activated. Then, the network node may receive a random access request from the apparatus for initial access to the cell.

### CROSS REFERENCE TO RELATED PATENT APPLICATION(S)

The present disclosure is part of a non-provisional application claiming the priority benefit of U.S. Patent Application No. 63/554,251, filed 16 Feb. 2024, the content of which herein being incorporated by reference in its entirety.

### TECHNICAL FIELD

The present disclosure is generally related to mobile communications and, more particularly, to paging adaptation to support enhanced beam configuration in wireless communications.

### BACKGROUND

Unless otherwise indicated herein, approaches described in this section are not prior art to the claims listed below and are not admitted as prior art by inclusion in this section.

In 3^{rd} generation partnership project (3GPP) Release 17, non-terrestrial network (NTN) is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) user equipment (UE). NR NTN uses the 5G NR framework to enable direct connection between satellites and smartphones to provide voice and data services.

Typically, the total satellite transmission power for downlink (DL) transmission on the service link is split equally between multiple beams that are simultaneously active. However, this will result in lower transmission power per active beam. FIG. 1 illustrates an example scenario 100 of satellite beam configuration under current NTN framework. As shown in FIG. 1, the satellite is configured with K_{active}=8 active beams, including 1 wide beam (or called coarse beam) and 7 narrow beams (or called fine beams). Assuming the total transmission power of the satellite as Sₜₒₜₐₗ, the transmission power available for each active beam would be Sₜₒₜₐₗ/N_{active}, resulting in a non-ideal signal-to-noise ratio (SNR) loss per beam of Loss=10*LOG10 (K_{active})=9 decibel (dB). Furthermore, under current NTN framework as specified in 3GPP, it is assumed that the beams are always ON (i.e., activated), which would be detrimental to power conservation.

Accordingly, how to enhance satellite beam configuration and adapt paging procedure to support enhanced satellite beam configuration becomes an important issue for modern wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to paging adaptation to support enhanced beam configuration in wireless communications. It is believed that the above-described issue would be avoided or otherwise alleviated by implementing one or more of the proposed schemes described herein.

In one aspect, a method may involve a network node configuring a cell with at least one wide beam and one or more narrow beams, wherein the wide beam is configured to be always activated and each of the narrow beams is configurable to be activated or deactivated. The method may also involve the network node transmitting a paging message to an apparatus in the cell, wherein the paging message is transmitted on at least one of the wide beam and the narrow beams that are activated. The method may further involve the network node receiving a random access request from the apparatus for initial access to the cell.

In one aspect, a method may involve an apparatus receiving a paging configuration from a network node, wherein the paging configuration indicates a plurality of paging occasions, each corresponding to one of at least one wide beam and one or more narrow beams of a cell associated with the network node. The method may also involve the apparatus receiving a paging message from the network node based on the paging configuration, wherein the paging message is received on at least one of the wide beam and the narrow beams. The method may further involve the apparatus transmitting a random access request to the network node for initial access to the cell.

In one aspect, a network node operating as a network node may comprise a transceiver which, during operation, wirelessly communicates with an apparatus. The network node may also comprise a processor communicatively coupled to the transceiver. The processor, during operation, may perform operations comprising configuring a cell with at least one wide beam and one or more narrow beams, wherein the wide beam is configured to be always activated and each of the narrow beams is configurable to be activated or deactivated. The processor may also perform operations comprising transmitting, via the transceiver, a paging message to the apparatus in the cell, wherein the paging message is transmitted on at least one of the wide beam and the narrow beams that are activated. The processor may further perform operations comprising receiving, via the transceiver, a random access request from the apparatus for initial access to the cell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of satellite beam configuration under current NTN framework.

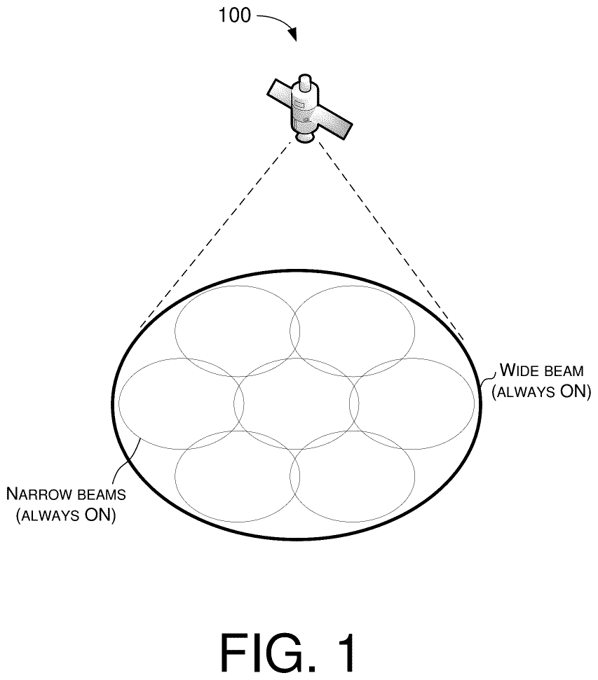

FIG. 2 is a diagram depicting an example scenario of a communication environment in which various solutions and schemes in accordance with the present disclosure may be implemented.

FIG. 3 is a diagram depicting an example scenario of enhanced satellite beam configurations in accordance with an implementation of the present disclosure.

FIG. 4 is a diagram depicting an example scenario of paging under enhanced satellite beam configuration in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to paging adaptation to support enhanced beam configuration in wireless communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has processing capabilities of modulation/demodulation, coding/decoding, switching, routing and so on.

Under current NTN framework, it is assumed that the beams are always ON (i.e., activated), which would be detrimental to power conservation. In legacy 5G NR, paging message is transmitted on the physical downlink control channel (PDCCH) via downlink control information (DCI) format 1_0 addressed to a paging-radio network temporary identifier (P-RNTI) linked to a group of UEs. However, if the satellite beam configuration is to be relaxed to allow the satellite to switch beams ON or OFF (i.e., deactivated), paging procedure will need to be adapted to ensure that the UE may be configured to receive the paging message when the beam is ON.

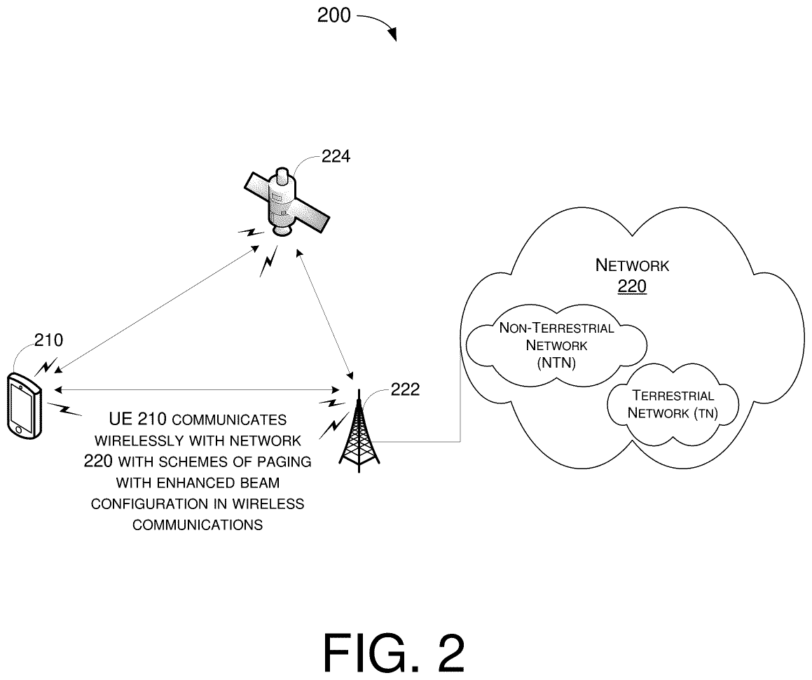

In view of the above, the present disclosure is motivated by, but not limited to, NTN scenarios, and accordingly proposes a number of schemes pertaining to paging adaptation to support enhanced beam configuration. FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including an NTN and a TN) via a terrestrial network node 222 (e.g., a base station (BS) such as an evolved Node-B (eNB), a Next Generation Node-B (gNB), or a transmission/reception point (TRP)) and/or a non-terrestrial network node 224 (e.g., a satellite). For example, the terrestrial network node 222 and/or the non-terrestrial network node 224 may form an TN/NTN serving cell for wireless communication with the UE 210. In such communication environment, the UE 210, the network 220, the terrestrial network node 222, and the non-terrestrial network node 224 may implement various schemes pertaining to paging adaptation to support enhanced beam configuration in wireless communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

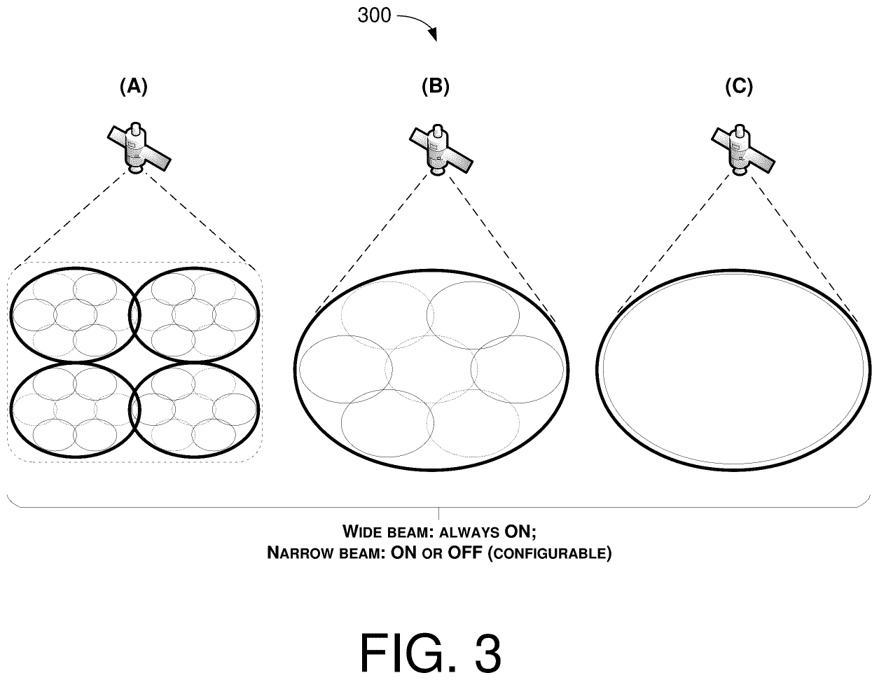

FIG. 3 illustrates an example scenario 300 of enhanced satellite beam configurations in accordance with an implementation of the present disclosure. Part (A) of FIG. 3 depicts a satellite forming a multiple-beam cell with 4 wide beams and 7 narrow beams within each wide beam. Part (B) of FIG. 3 depicts a satellite forming a multiple-beam cell with 1 wide beam and 7 narrow beams within the wide beam. Part (C) of FIG. 3 depicts a satellite forming a single-beam cell. In general, each wide beam and narrow beam covers a geographical area where one or more UEs may be located. For example, a wide beam may cover a relatively large area to serve UE(s) within that area for DL synchronization, system information (e.g., at least system information block type 1 (SIB1)) acquisition, and/or initial access. A narrow beam may cover a relatively small area to serve UE(s) within that area for data transmission. More specifically, the wider beam(s) may be configured to be always ON (denoted with solid line in FIG. 3), while the narrow beams may be configured to be ON or OFF (denoted with dotted line in FIG. 3) as required.

Under the first proposed scheme in accordance with the present disclosure, network may transmit the paging message on a wide beam on PDCCH assuming minimum SNR consistent with legacy PDCCH (or Release 19 (R19) PDCCH enhancements). Subsequently, the same random access channel PRACH) procedure may be applied for initial access. In some implementations, the UE may select a physical random access channel (PRACH) resource associated with a narrow beam, a non-cell-defining (NCD) synchronization signal block (SSB) index, or a channel state information-reference signal (CSI-RS). In some implementations, the UE may transmit a random access request (e.g., a PRACH preamble) on a wide/narrow beam, and the network may determine a narrow beam based on the direction or angle-of-arrival (AoA) of the random access request.

Alternatively, in some implementations, the UE may use some assistance information provided by the network (e.g., through system information block type 19 (SIB19)) to select an appropriate narrow beam and then transmit the random access request on this narrow beam. The assistance information may include at least one of the following: (i) index or indices of the narrow beam(s); (ii) reference point(s) or distance threshold(s) to the narrow beam(s); (iii) offset(s) of differential power gain on the wide beam or the narrow beam(s); and (iv) PRACH resource(s) (e.g., represented by time and frequency domain location(s)) or PRACH preamble set(s) associated with the narrow beam(s). The UE may use the assistance information to select an appropriate narrow beam, e.g., based on the UE's position. Next, the UE may use a PRACH resource associated with the selected narrow beam to trigger the RACH procedure on the selected narrow beam, complete the initial access on the narrow beam, and then receive UE-specific radio resource control (RRC) configuration applicable to the narrow beam.

Under the second proposed scheme in accordance with the present disclosure, the network may transmit the paging message on a narrow beam, e.g., based on the position assuming UE has not moved out of beam diameter cell where it was last active. Additionally, the network may configure paging opportunities associated with the narrow beams or wide beam. For example, if there are 8 beams in total, then 8 paging occasions are configured in the paging configuration provided to the UE. Assuming one SSB is associated per paging occasion (e.g., the same as defined in 3GPP R15), the UE may try blindly detecting the paging message on the narrow beams. Alternatively, the UE may know which narrow beam to check for the paging message based on some assistance information provided by the network (as above-described in the first proposed scheme).

Under the third proposed scheme in accordance with the present disclosure, the network may transmit the paging message in a beam sweeping manner, if needed. For example, the network may transmit the paging message on one narrow beam at a time, and then on the wide beam. The UE may try blindly detecting the paging message on the narrow beams or the wide beam. Additionally, the network may configure paging opportunities associated with the narrow beams or wide beam. For example, if there are 8 beams in total, then 8 paging occasions are configured in the paging configuration provided to the UE, where one SSB is associated per paging occasion.

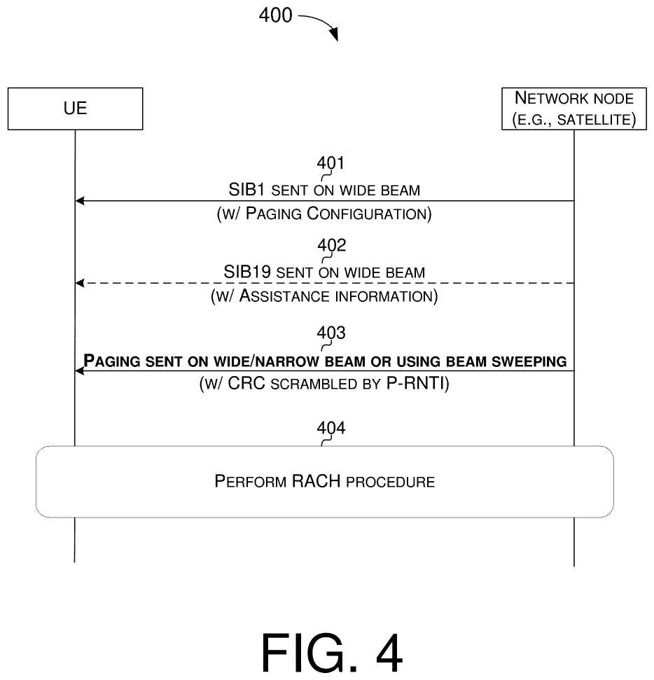

FIG. 4 illustrates an example scenario 400 of paging under enhanced satellite beam configuration in accordance with an implementation of the present disclosure. In step 401, the network may transmit the system information block type 1 (SIB1) including the paging configuration to the UE. Specifically, the paging configuration indicates a plurality of paging occasions, each corresponding to one of the wide beam and the (activated) narrow beams. In step 402, the network may optionally transmit the SIB19 including some assistance information to the UE. The assistance information may be used later by the UE in narrow beam selection for transmitting the random access request (e.g., a PRACH preamble). In step 403, the network may transmit a paging message on the wide beam or an activated narrow beam, or using beam sweeping, depending on which proposed scheme of the present disclosure is applied. Specifically, the cyclic redundancy check (CRC) of the paging message is scrambled with a P-RNTI of a UE group to which the UE belongs. In step 404, upon receiving the paging message and successfully decoding the paging message with the P-RNTI, the UE may perform RACH procedure by transmitting a random access request (e.g., a PRACH preamble) to the network. In one example, the random access request may be transmitted on the wide beam. In another example, the random access request may be transmitted on a narrow beam, e.g., selected based on the assistance information received in step 402.

### Illustrative Implementations

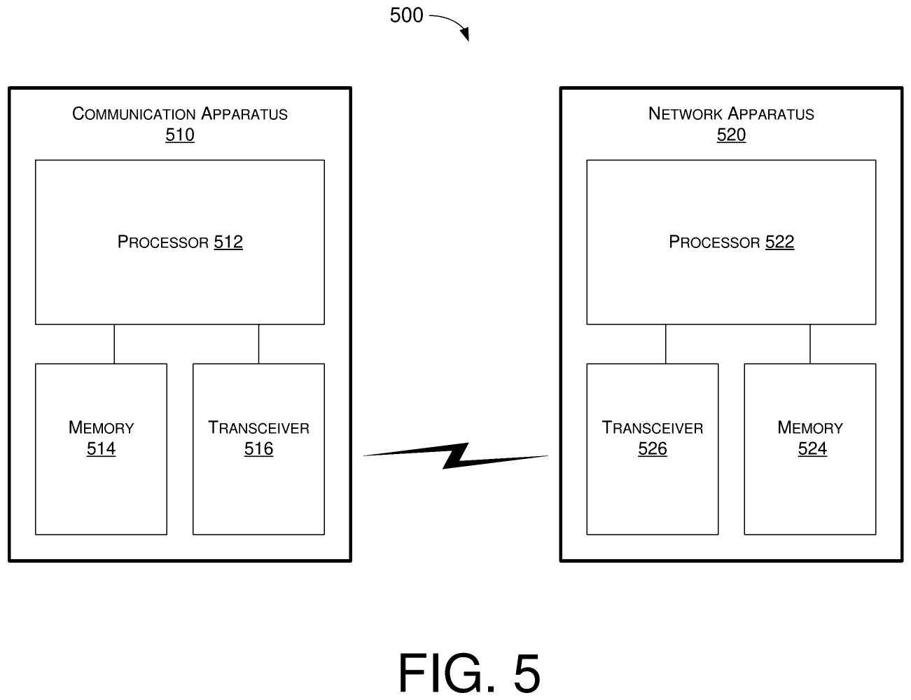

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to paging adaptation to support enhanced beam configuration in wireless communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a base station (BS), a small cell, a router or a gateway of an NTN. For instance, network apparatus 520 may be implemented in a satellite or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including paging adaptation to support enhanced beam configuration in wireless communications, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for beamforming and multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for beamforming and MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., a satellite or BS), is provided below with processes 600 and 700.

### Illustrative Processes

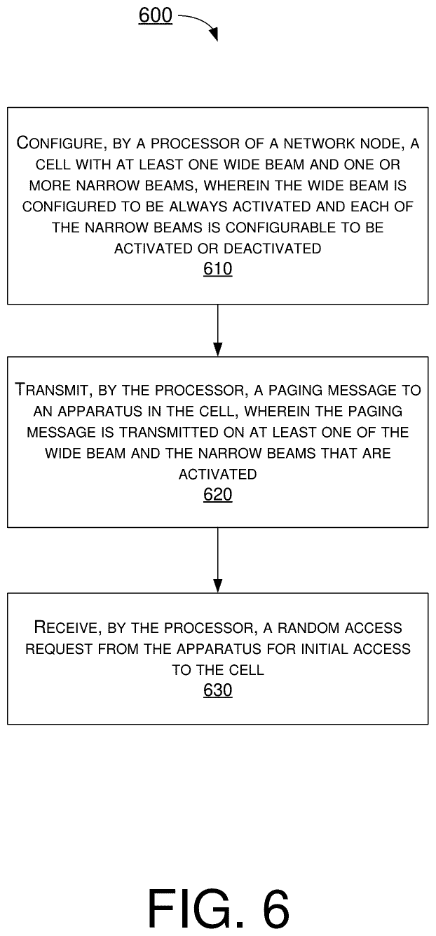

FIG. 6 illustrates an example process 600 in accordance with an implementation of the present disclosure. Process 600 may be an example implementation of above scenarios/schemes, whether partially or completely, with respect to paging adaptation to support enhanced beam configuration in wireless communications. Process 600 may represent an aspect of implementation of features of network apparatus 520. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in network apparatus 520 as well as any variations thereof. Solely for illustrative purposes and without limitation, process 600 is described below in the context of communication apparatus 510, as a UE, and network apparatus 520, as a network node. Process 600 may begin at block 610.

At 610, process 600 may involve processor 522 of network apparatus 520 configuring a cell with at least one wide beam and one or more narrow beams, wherein the wide beam is configured to be always activated and each of the narrow beams is configurable to be activated or deactivated. Process 600 may proceed from block 610 to block 620.

At 620, process 600 may involve processor 522 transmitting, via transceiver 526, a paging message to communication apparatus 510 in the cell, wherein the paging message is transmitted on at least one of the wide beam and the narrow beams that are activated. Process 600 may proceed from block 620 to block 630.

At 630, process 600 may involve processor 522 receiving, via transceiver 526, a random access request from communication apparatus 510 for initial access to the cell.

In some implementations, process 600 may further involve processor 522 transmitting, via transceiver 526, assistance information to communication apparatus 510, wherein the assistance information includes at least one of the following: (i) one or more indices of the narrow beams; (ii) one or more reference points or distance thresholds to the narrow beams; (iii) one or more offsets of differential power gain on the wide beam or the narrow beams; and (iv) one or more PRACH resources or PRACH preamble sets associated with the narrow beams.

In some implementations, process 600 may further involve processor 522 determining one of the narrow beams based on a direction or an AoA of the random access request.

In some implementations, process 600 may further involve processor 522 obtaining a position where communication apparatus 510 was last active, wherein the paging message is transmitted on one of the narrow beams based on the position.

In some implementations, process 600 may further involve processor 522 transmitting, via transceiver 526, a paging configuration to communication apparatus 510, wherein the paging configuration indicates a plurality of paging occasions, each corresponding to one of the wide beam and the narrow beams.

In some implementations, the paging message may be transmitted in a beam sweeping manner on the wide beam and the narrow beams.

In some implementations, the wide beam may be configured for DL synchronization, system information acquisition, or initial access, and the narrow beams may be configured for data transmission.

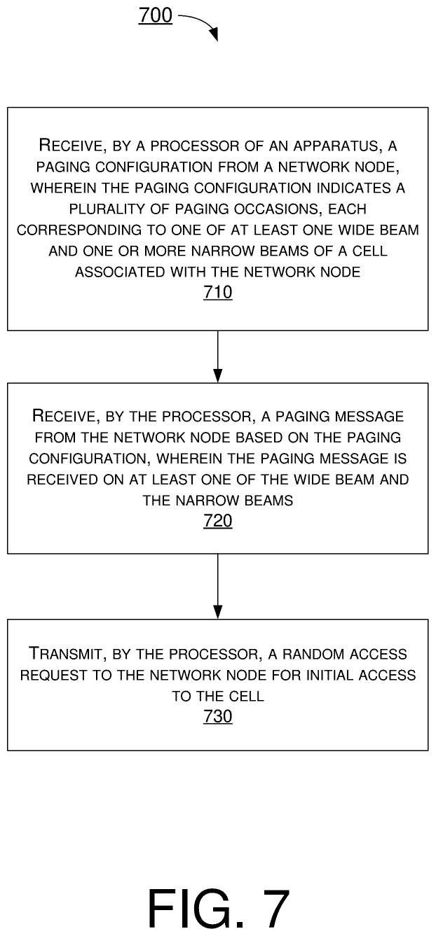

FIG. 7 illustrates an example process 700 in accordance with an implementation

of the present disclosure. Process 700 may be an example implementation of above scenarios/schemes, whether partially or completely, with respect to paging adaptation to support enhanced beam configuration in wireless communications. Process 700 may represent an aspect of implementation of features of communication apparatus 510. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in communication apparatus 510 as well as any variations thereof. Solely for illustrative purposes and without limitation, process 700 is described below in the context of communication apparatus 510, as a UE, and network apparatus 520, as a network node. Process 700 may begin at block 710.

At 710, process 700 may involve processor 512 of communication apparatus 510 receiving, via transceiver 516, a paging configuration from network apparatus 520, wherein the paging configuration indicates a plurality of paging occasions, each corresponding to one of at least one wide beam and one or more narrow beams of a cell associated with the network node. Process 700 may proceed from block 710 to block 720.

At 720, process 700 may involve processor 512 receiving, via transceiver 516, a paging message from network apparatus 520 based on the paging configuration, wherein the paging message is received on at least one of the wide beam and the narrow beams. Process 700 may proceed from block 720 to block 730.

At 730, process 700 may involve processor 512 transmitting, via transceiver 516, a random access request to network apparatus 520 for initial access to the cell.

In some implementations, process 700 may further involve processor 512 receiving, via transceiver 516, assistance information from network apparatus 520, and selecting one of the narrow beams based on the assistance information, wherein the random access request is transmitted on the selected narrow beam.

In some implementations, the assistance information may include at least one of the following: (i) one or more indices of the narrow beams; (ii) one or more reference points or distance thresholds to the narrow beams; (iii) one or more offsets of differential power gain on the wide beam or the narrow beams; and (iv) one or more PRACH resources or PRACH preamble sets associated with the narrow beams.

In some implementations, process 700 may further involve processor 512 selecting a PRACH resource that is associated with a narrow beam, an NCD SSB index, or a CSI-RS, wherein the random access request is transmitted based on the selected PRACH resource.

In some implementations, the assistance information may be received in system information (e.g., SIB19).

In some implementations, the wide beam may be configured for DL synchronization, system information acquisition, or initial access, and the narrow beams may be configured for data transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor of a network node, a cell with at least one wide beam and one or more narrow beams, wherein the wide beam is configured to be always activated and each of the narrow beams is configurable to be activated or deactivated;
transmitting, by the processor, a paging message to an apparatus in the cell, wherein the paging message is transmitted on at least one of the wide beam and the narrow beams that are activated; and
receiving, by the processor, a random access request from the apparatus for initial access to the cell.

2. The method of claim 1, further comprising:
transmitting, by the processor, assistance information to the apparatus, wherein the assistance information comprises at least one of the following:
one or more indices of the narrow beams;
one or more reference points or distance thresholds to the narrow beams;
one or more offsets of differential power gain on the wide beam or the narrow beams; and
one or more physical random access channel (PRACH) resources or PRACH preamble sets associated with the narrow beams.

3. The method of claim 1, further comprising:
determining, by the processor, one of the narrow beams based on a direction or an angle-of-arrival (AoA) of the random access request.

4. The method of claim 1, further comprising:
obtaining, by the processor, a position where the apparatus was last active,
wherein the paging message is transmitted on one of the narrow beams based on the position.

5. The method of claim 1, further comprising:
transmitting, by the processor, a paging configuration to the apparatus, wherein the paging configuration indicates a plurality of paging occasions, each corresponding to one of the wide beam and the narrow beams.

6. The method of claim 1, wherein the paging message is transmitted in a beam sweeping manner on the wide beam and the narrow beams.

7. The method of claim 1, wherein the wide beam is configured for downlink (DL) synchronization, system information acquisition, or initial access, and the narrow beams are configured for data transmission.

8. A method, comprising:
receiving, by a processor of an apparatus, a paging configuration from a network node, wherein the paging configuration indicates a plurality of paging occasions, each corresponding to one of at least one wide beam and one or more narrow beams of a cell associated with the network node;
receiving, by the processor, a paging message from the network node based on the paging configuration, wherein the paging message is received on at least one of the wide beam and the narrow beams; and
transmitting, by the processor, a random access request to the network node for initial access to the cell.

9. The method of claim 8, further comprising:
receiving, by the processor, assistance information from the network node; and
selecting, by the processor, one of the narrow beams based on the assistance information, wherein the random access request is transmitted on the selected narrow beam.

10. The method of claim 9, wherein the assistance information comprises at least one of the following:
one or more indices of the narrow beams;
one or more reference points or distance thresholds to the narrow beams;
one or more offsets of differential power gain on the wide beam or the narrow beams; and
one or more physical random access channel (PRACH) resources or PRACH preamble sets associated with the narrow beams.

11. The method of claim 8, further comprising:
selecting, by the processor, a physical random access channel (PRACH) resource that is associated with a narrow beam, a non-cell-defining (NCD) synchronization signal block (SSB) index, or a channel state information-reference signal (CSI-RS), wherein the random access request is transmitted based on the selected PRACH resource.

12. The method of claim 9, wherein the assistance information is received in system information.

13. The method of claim 8, wherein the wide beam is configured for downlink (DL) synchronization, system information acquisition, or initial access, and the narrow beams are configured for data transmission.

14. A network node, comprising:
a transceiver which, during operation, wirelessly communicates with an apparatus; and
a processor communicatively coupled to the transceiver such that, during operation, the processor performs operations comprising:
configuring a cell with at least one wide beam and one or more narrow beams, wherein the wide beam is configured to be always activated and each of the narrow beams is configurable to be activated or deactivated;
transmitting, via the transceiver, a paging message to the apparatus in the cell, wherein the paging message is transmitted on at least one of the wide beam and the narrow beams that are activated; and
receiving, via the transceiver, a random access request from the apparatus for initial access to the cell.

15. The network node of claim 14, wherein, during operation, the processor further performs operations comprising:
transmitting, via the transceiver, assistance information to the apparatus, wherein the assistance information comprises at least one of the following:
one or more indices of the narrow beams;
one or more reference points or distance thresholds to the narrow beams;
one or more offsets of differential power gain on the wide beam or the narrow beams; and
one or more physical random access channel (PRACH) resources or PRACH preamble sets associated with the narrow beams.

16. The network node of claim 14, wherein, during operation, the processor further performs operations comprising:
determining one of the narrow beams based on a direction or an angle-of-arrival (AoA) of the random access request.

17. The network node of claim 14, wherein, during operation, the processor further performs operations comprising:
obtaining a position where the apparatus was last active,
wherein the paging message is transmitted on one of the narrow beams based on the position.

18. The network node of claim 14, wherein, during operation, the processor further performs operations comprising:
transmitting, via the transceiver, a paging configuration to the apparatus, wherein the paging configuration indicates a plurality of paging occasions, each corresponding to one of the wide beam and the narrow beams.

19. The network node of claim 14, wherein the paging message is transmitted in a beam sweeping manner on the wide beam and the narrow beams.

20. The network node of claim 14, the wide beam is configured for downlink (DL) synchronization, system information acquisition, or initial access, and the narrow beams are configured for data transmission.
